(19) United States
(12) Patent Application Publication
(10) Pub. No.: US 2025/0278943 A1
(43) Pub. Date: Sep. 4, 2025

(54) OBJECT RECOGNITION DEVICE, OBJECT RECOGNITION METHOD, AND NON-TRANSITORY COMPUTER-READABLE STORAGE MEDIUM STORING OBJECT RECOGNITION PROGRAM

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventor: MASANARI TAKAKI, Nisshin-shi (JP)

(21) Appl. No.: 19/014,657

(22) Filed: Jan. 9, 2025

(30) Foreign Application Priority Data
Mar. 1, 2024 (JP) 2024-031381

(51) Int. Cl. G06V 20/58; G06V 10/776

(52) U.S. Cl. CPC G06V 20/58; G06V 10/776

(57) ABSTRACT

An object recognition device is disposed in a vehicle and includes a sensor information obtaining unit, an object detecting unit, an integration processing unit, and a recognition processing unit. The sensor information obtaining unit obtains detection information from various types of object sensors. The object detecting unit generates an object detection result corresponding to the detection information. The integration processing unit generates a detection performance curve for each of the various types of object sensors, calculates a confidence level of the object detection result using the detection performance curve, and integrates the confidence level of the object detection result for each of the various types of object sensors. The recognition processing unit recognizes the object based on the integrated result. The integration processing unit generates the detection performance curve based on at least one of a driving environment of the vehicle or feedback information of the object recognition result.

### CROSS REFERENCE TO RELATED APPLICATION

The present application claims the benefit of priority from Japanese Patent Application No. 2024-031381 filed on Mar. 1, 2024. The entire disclosure of the above application is incorporated herein by reference.

### TECHNICAL FIELD

The present disclosure relates to an object recognition device mounted in a vehicle, an object recognition method, and a non-transitory computer-readable storage medium storing an object recognition program.

### BACKGROUND

Various devices that perform so-called sensor fusion processing to recognize an object around a vehicle have been known.

### SUMMARY

According to one aspect of the present disclosure, an object recognition device that is disposed in a vehicle and configured to recognize an object around the vehicle with various types of object sensors is provided. The object recognition device includes a sensor information obtaining unit, an object detection unit, an integration processing unit, and a recognition processing unit. The sensor information obtaining unit is configured to obtain detection information from each of the various types of object sensors mounted on the vehicle. The object detection unit is configured to generate an object detection result for each of the various types of object sensors corresponding to the detection information obtained by the sensor information obtaining unit. The integration processing unit is configured to generate a detection performance curve for each of the various types of object sensors, calculate a confidence level for the object detection result of each of the various types of object sensors using the detection performance curve, and generate an integrated result by integrating the calculated confidence level of each of the various types of object sensors. The recognition processing unit is configured to generate an object recognition result by recognizing the object based on the integration result of the confidence level. The integration processing unit is configured to generate the detection performance curve based on at least one of a driving environment of the vehicle or feedback information of the object recognition result by the recognition processing unit.

According to another aspect of the present disclosure, an object recognition method executed by an object recognition device is provided. The object recognition device is mounted on a vehicle and configured to recognize an object around the vehicle with various types of object sensors. The object recognition method includes: obtaining detection information from each of the various types of object sensors mounted on the vehicle; generating an object detection result corresponding to the detection information of each of the various types of object sensors obtained by the sensor information obtaining unit; generating a detection performance curve for each of the various types of the object sensors; calculating a confidence level for the object detection result of each of the various types of object sensors using the detection performance curve; generating an integrated result by integrating the calculated confidence level for the object detection result of each of the various types of object sensors; generating an object recognition result by recognizing the object based on the integrated result of the confidence level of each of the various types of object sensors. The generating of the detection performance curve is generating the detection performance curve based on at least one of a driving environment of the vehicle or feedback information of the object recognition result.

In yet another aspect of the present disclosure, a non-transitory computer-readable storage medium including an object recognition program executed by an object recognition device is provided. The object recognition device is mounted on a vehicle and configured to recognize an object around the vehicle. The object recognition program is configured to, when executed by the object recognition device, cause the object recognition device to: obtain detection information from each of various types of object sensors mounted on the vehicle; generate an object detection result corresponding to the detection information for each of the various types of object sensors; generate a detection performance curve for each of the various types of object sensors; calculate a confidence level for the object detection result of each of the various types of object sensors using the detection performance curve; generate an integrate result by integrating the calculated confidence level for the object detection result of each of the various types of object sensors; generating an object recognition result by recognizing the object based on the integration result of the confidence level of each of the various types of object sensors. The detection performance curve is generated based on at least one of a driving environment of the vehicle or feedback information of the object recognition result.

### BRIEF DESCRIPTION OF THE DRAWINGS

FIG. 1 is a schematic diagram showing a state in which a vehicle equipped with an in-vehicle system including an object recognition device according to an embodiment of the present disclosure is traveling.

FIG. 2 is a block diagram illustrating a schematic configuration of the in-vehicle system shown in FIG. 1.

FIG. 3 is a block diagram illustrating a schematic functional configuration of an object recognition device shown in FIG. 2.

FIG. 4A is a conceptual diagram schematically showing an object recognition operation by the object recognition device shown in FIG. 3.

FIG. 4B is a diagram explaining output of a confidence assignment information.

FIG. 5 is a flowchart schematically showing an integration process realized by an integration process function shown in FIG. 3.

FIG. 6 is a flowchart showing a specific example of a confidence calculation process shown in FIG. 5.

FIG. 7 is a graph schematically showing a theoretical PR curve generated by a theoretical PR curve generation process shown in FIG. 6.

FIG. 8 is a flowchart showing a specific example of the theoretical PR curve generation process shown in FIG. 6.

FIG. 9 is a table used to calculate a coefficient Keₘ in a Keₘ calculation process shown in FIG. 8.

FIG. 10 is a flowchart showing a specific example of a Krₘ calculation process shown in FIG. 8.

FIG. 11 is a table used to calculate a coefficient Krₘ in the Krₘ calculation process shown in FIG. 10.

### DETAILED DESCRIPTION OF THE PREFERRED EMBODIMENTS

To begin with, examples of relevant techniques will be described.

Various devices that perform so-called sensor fusion processing to recognize an object around a vehicle have been known. For example, the external environment recognition device recognizes the external environment of the vehicle equipped with multiple types of sensors. The detection ranges of the sensors are at least partially overlapped. The external environment recognition device includes an obtaining unit, a setting unit, and a generation unit. The obtaining unit obtains detection information from a camera, a laser radar, and a radio wave radar. The laser radar is also referred to as LiDAR. LIDAR is an abbreviation for Light Detection and Ranging or Laser Imaging Detection and Ranging. The setting unit sets a weight for each piece of detection information relating to the overlapping portion of the detection range in accordance with the vehicle driving scene. The generation unit integrates the detection information to which a weight has been set, and generates recognition information of the external environment. According to this configuration, the external environment can be recognized more accurately through sensor fusion processing.

Specifically, in a sidewall curve scene where the vehicle is moving through a curved section on a road with sidewalls, the setting unit sets the weight of the detection information obtained by the radio wave radar to the smallest value, and sets the weight of the detection information obtained by the laser radar to a greater value than the weight of the detection information obtained by the camera. In addition, during a weight adjustment period after entering a dark area from a bright area, the setting unit sets the weight of the detection information obtained by the laser radar to a greater value than the weight of the detection information obtained by the camera. On the other hand, in a bright area entry scene immediately after entering a bright area from a dark area, the setting unit sets the weight of the detection information obtained by the camera to a smaller value than the weight of the detection information obtained by the laser radar. In addition, in a snowfall scene, the setting unit sets the weight of the detection information obtained by the camera to a smaller value than the weight of the detection information obtained by the laser radar, and sets the weight of the detection information obtained by the laser radar to a greater value than the weight of the detection information obtained by the radio wave radar. In addition, in a driving scene where a specific electromagnetic wave condition related to multiple reflection of electromagnetic waves is met, the setting unit sets the weight of the detection information obtained by the camera to a greater value than the weight of the detection information obtained by the laser radar and the radio wave radar. In addition, in a driving scene where a specific actual scene reflection condition related to reflectors that reflect the actual external scene is met, the setting unit sets the weight of the detection information obtained by the camera to a smaller value than the weights of the detection information obtained by the laser radar and the radio wave radar.

In this type of devices, various attempts have been made to further improve the recognition accuracy. The present disclosure has been made in view of the circumstances and the like exemplified above.

According to one aspect of the present disclosure, an object recognition device that is disposed in a vehicle and configured to recognize an object around the vehicle with various types of object sensors is provided. The object recognition device includes a sensor information obtaining unit, an object detection unit, an integration processing unit, and a recognition processing unit. The sensor information obtaining unit is configured to obtain detection information from each of the various types of object sensors mounted on the vehicle. The object detection unit is configured to generate an object detection result for each of the various types of object sensors corresponding to the detection information obtained by the sensor information obtaining unit. The integration processing unit is configured to generate a detection performance curve for each of the various types of object sensors, calculate a confidence level for the object detection result of each of the various types of object sensors using the detection performance curve, and generate an integrated result by integrating the calculated confidence level of each of the various types of object sensors. The recognition processing unit is configured to generate an object recognition result by recognizing the object based on the integration result of the confidence level. The integration processing unit is configured to generate the detection performance curve based on at least one of a driving environment of the vehicle or feedback information of the object recognition result by the recognition processing unit.

According to another aspect of the present disclosure, an object recognition method executed by an object recognition device is provided. The object recognition device is mounted on a vehicle and configured to recognize an object around the vehicle with various types of object sensors. The object recognition method includes: obtaining detection information from each of the various types of object sensors mounted on the vehicle; generating an object detection result corresponding to the detection information of each of the various types of object sensors obtained by the sensor information obtaining unit; generating a detection performance curve for each of the various types of the object sensors; calculating a confidence level for the object detection result of each of the various types of object sensors using the detection performance curve; generating an integrated result by integrating the calculated confidence level for the object detection result of each of the various types of object sensors; generating an object recognition result by recognizing the object based on the integrated result of the confidence level of each of the various types of object sensors. The generating of the detection performance curve is generating the detection performance curve based on at least one of a driving environment of the vehicle or feedback information of the object recognition result.

In yet another aspect of the present disclosure, a non-transitory computer-readable storage medium including an object recognition program executed by an object recognition device is provided. The object recognition device is mounted on a vehicle and configured to recognize an object around the vehicle. The object recognition program is configured to, when executed by the object recognition device, cause the object recognition device to: obtain detection information from each of various types of object sensors mounted on the vehicle; generate an object detection result corresponding to the detection information for each of the various types of object sensors; generate a detection performance curve for each of the various types of object sensors; calculate a confidence level for the object detection result of each of the various types of object sensors using the detection performance curve; generate an integrate result by integrating the calculated confidence level for the object detection result of each of the various types of object sensors; generating an object recognition result by recognizing the object based on the integration result of the confidence level of each of the various types of object sensors. The detection performance curve is generated based on at least one of a driving environment of the vehicle or feedback information of the object recognition result.

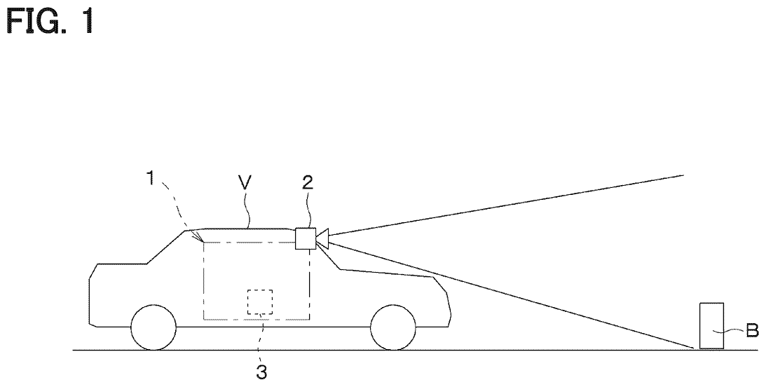

(Embodiment) Exemplary embodiments and specific examples of the present disclosure will be described below with reference to the drawings. As shown in FIG. 1, an in-vehicle system 1 is mounted on a vehicle V and configured to execute various operations in the vehicle. Hereinafter, the vehicle V equipped with the in-vehicle system 10 is referred to as “own vehicle”. Specifically, the in-vehicle system 1 is configured to recognize an object B around the own vehicle using object sensors 2 and perform driving assistance operations such as preceding vehicle following driving and collision avoiding using a driving assistance device 3 based on the recognition results.

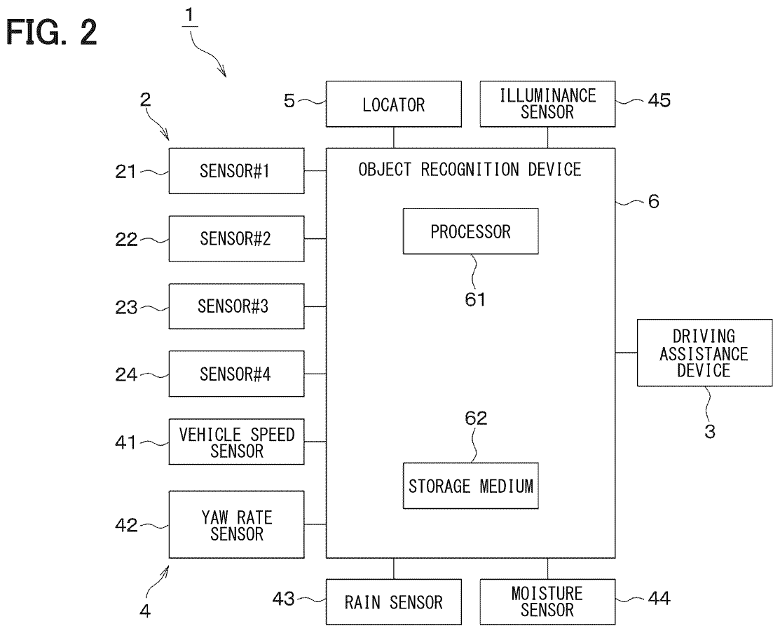

(In-Vehicle System Configuration) With reference to FIG. 2, the in-vehicle system 1 includes object sensors 2, the driving assistance device 3, vehicle state sensors 4, a locator 5, and an object recognition device 6. The object sensors 2, the driving assistance device 3, the vehicle state sensors 4, the locator 5, and the object recognition device 6 are connected to each other via an in-vehicle network to exchange signals with each other. The in-vehicle network is configured to conform to a predetermined communication standard such as CAN (international registered trademark: international registered number 1048262A). CAN (international registered trademark) is an abbreviation for Controller Area Network. The in-vehicle network may include sub-network conforming to LIN, FlexRay, or the like in addition to a main network conforming to CAN (international registered trademark). LIN is an abbreviation for Local Interconnect Network. The schematic configuration and function of each part of the in-vehicle system 1 will be described below.

In this embodiment, the in-vehicle system 1 includes the object sensors 2 including a first sensor 21, a second sensor 22, a third sensor 23, and a fourth sensor 24. The first sensor 21 to the fourth sensor 24 are configured to detect the object B using different detection principles, respectively. Specifically, for example, the first sensor 21 has a configuration as a so-called in-vehicle camera sensor including an image sensor such as a CCD or a CMOS. CCD is an abbreviation for Charge-Coupled Device. CMOS is an abbreviation for Complementary Metal Oxide Semiconductor. Further, for example, the second sensor 22 has a configuration as a so-called millimeter wave radar sensor that detects the relative position and relative speed of the object B with respect to the vehicle by emitting radio waves having millimeter wave band and receiving the radio waves reflected by the object B. Furthermore, for example, the third sensor 23 has a configuration as a so-called laser radar sensor that detects the distance and direction to the object B by using laser light. Also, for example, the fourth sensor 24 has a so-called sonar configuration that detects the distance and direction to the object B using ultrasonic waves.

The driving assistance device 3 has a configuration as a so-called driving assistance ECU that controls a driving force generation mechanism, a driving force transmission mechanism, a braking mechanism, and the like to execute a driving assistance operation. ECU is an abbreviation for Electronic Control Unit. Here, “driving assistance” refers to that the in-vehicle system 1 continuously executes at least one of a longitudinal vehicle motion control subtask and a lateral vehicle motion control subtask. The longitudinal vehicle motion control subtask includes starting, acceleration/deceleration, and stopping of the vehicle. The lateral vehicle motion control subtask includes steering of the vehicle. In other words, in this specification, “driving assistance” includes “driving assistance” in the narrow sense in which the longitudinal vehicle motion control subtask and the lateral vehicle motion control subtask are not executed simultaneously, and “advanced driving assistance” in which both are executed simultaneously. In this way, the in-vehicle system 1 is configured to achieve level 1 or level 2 driving automation in the own vehicle, as defined in the standard “SAE J3016” published by SAE International. SAE stands for Society of Automotive Engineers.

The vehicle state sensors 4 are configured to generate outputs corresponding to various parameters related to the driving state of the own vehicle. The “driving state” includes the driving operation state, driving behavior state, and driving environment state of the own vehicle. The “driving operation state” refers to the state of the driving operation of the own vehicle input by the driver of the vehicle or the driving assistance device 3. The driving operation state indicates, for example, the steering amount, the throttle opening degree, the brake operation amount, the shift range, and the like. The “driving behavior state” refers to the state related to the movement or behavior of the own vehicle. The driving behavior state indicates, for example, the vehicle speed, the acceleration rate, the yaw rate, and the like. The “driving environment state” refers to the environment around the vehicle, and is different from the state of existence of an object B that is the target of detection or sensing by the object sensors 2. The driving environment state indicates, for example, the illuminance, the weather, the road surface conditions, etc. around the own vehicle.

Specifically, in this embodiment, the in-vehicle system 1 includes at least a vehicle speed sensor 41, a yaw rate sensor 42, a rain sensor 43, a moisture sensor 44, and an illuminance sensor 45 as the vehicle state sensors 4. The vehicle speed sensor 41 detects the speed of the vehicle. The yaw rate sensor 42 detects the yaw rate of the vehicle. The rain sensor 43 is a so-called raindrop sensor, and is configured to generate an output corresponding to the state of raindrops adhering to a predetermined area on the upper end of the front windshield of the vehicle. The moisture sensor 44 is configured to detect a state of the road surface ahead of the vehicle (a dry state or a wet state). The illuminance sensor 45 detects the illuminance around the vehicle. These sensors are already well known at the time of filing this application, and therefore a detailed description thereof will be omitted in this specification.

The locator 5 is configured to measure the position of the vehicle. Specifically, the locator 5 has at least a satellite positioning function that measures the position of the vehicle by receiving positioning signals transmitted from a positioning satellite. In addition, the locator 5 may use an autonomous positioning function with inertial sensors such as a gyro sensor or an acceleration sensor in order to improve the measurement accuracy of the position of the vehicle in places where satellite radio waves are difficult to reach, such as inside tunnels. Such an inertial sensor may be provided in the locator 5 or may be one of the vehicle state sensors 4. The locator 5 equipped with an inertial sensor is commercially available as a positioning and orientation system for land vehicles “POSLV” manufactured by Applanix, for example. The locator 5 is also configured to obtain the road type, the curve curvature, and the like at the current traveling position of the vehicle based on the positioning result of the vehicle and map information.

(Object Recognition Device) The object recognition device 6 has a configuration as an in-vehicle computer, that is, an object recognition ECU, capable of executing so-called sensor fusion processing, which integrates detection results from various types of the object sensors 2. Specifically, the object recognition device 6 includes a processor 61 consisting of a CPU or an MPU, and a storage medium 62 communicatively connected to the processor 61. The object recognition device 6 is configured to realize a predetermined function for recognizing an object B around the vehicle by the processor 61 reading and executing a computer program from the storage medium 62. The storage medium 62 includes at least a ROM or a non-volatile rewritable memory among various non-transitory tangible storage media. The non-volatile rewritable memory is a storage device, such as a flush memory, which allows information to be rewritten while the power is on, but retains the information in a non-rewritable manner while the power is off. The storage medium 62 stores the above-mentioned computer programs as well as various data such as initial values, maps, look-up tables, and the like required to execute the programs.

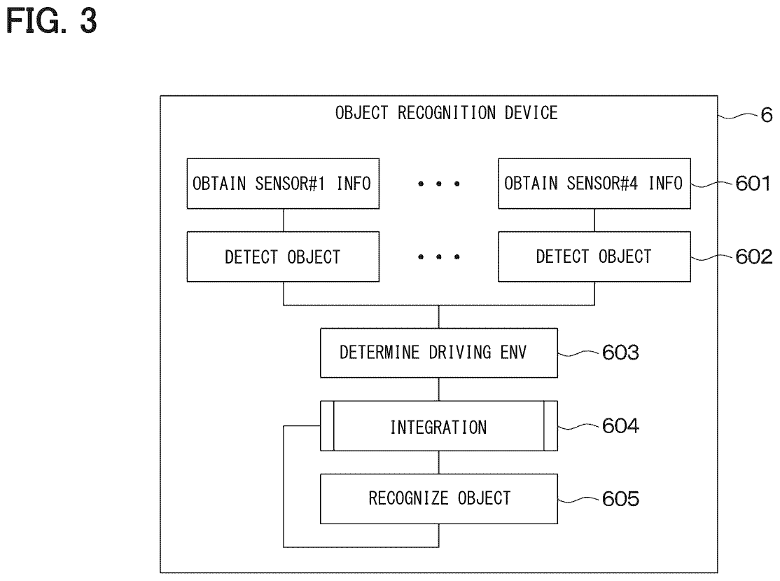

As shown in FIG. 3, the object recognition device 6 has, as functional configurations realized on the in-vehicle microcontroller executing the computer programs, a sensor information obtaining function 601, an object detection function 602, a driving environment determination function 603, an integration processing function 604, and an object recognition processing function 605. Hereinafter, the details of the functional configurations will be described in order.

The sensor information obtaining function 601 and the object detection function 602 are provided corresponding to each of the object sensors 2. The sensor information obtaining function 601, which corresponds to the sensor information obtaining unit in the present disclosure, is configured to obtain, i.e., receive, detection information from the corresponding object sensor 2. The object detection function 602, which corresponds to the object detection unit in the present disclosure, is configured to generate an object detection result corresponding to the detection information obtained by the sensor information obtaining function 601. The driving environment determination function 603 determines the driving environment of the vehicle based on the output information obtained from the object sensors 2 or the vehicle state sensors 4. The details of the driving environment determination will be described later. The integration processing function 604, which corresponds to the integration processing unit in the present disclosure, is configured to integrate multiple pieces of the detection information from the multiple object sensors 2. The object recognition processing function 605, which corresponds to the recognition processing unit in the present disclosure, is configured to recognize an object based on the integration result by the integration processing function 604. In addition, the object recognition processing function 605 outputs feedback information on the object recognition result to the integration processing function 604.

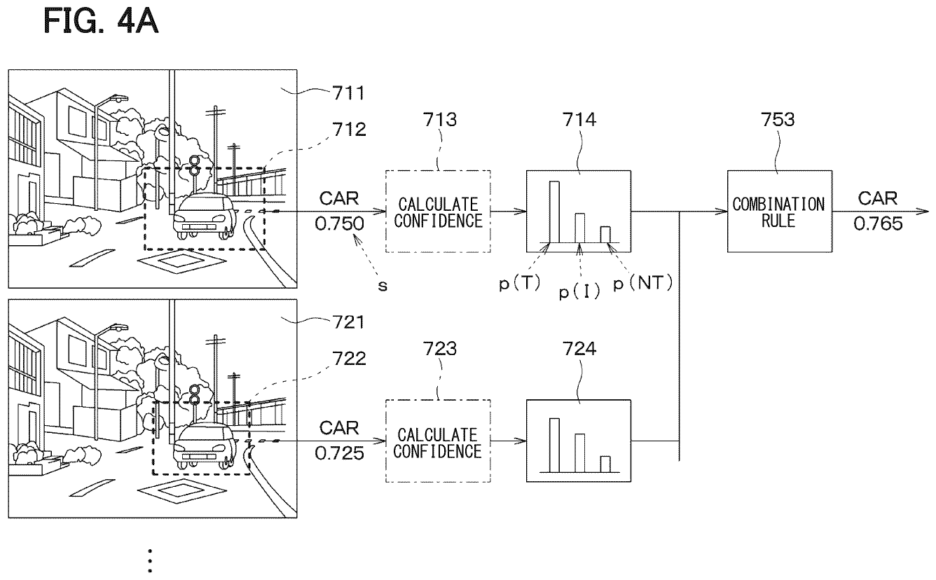

(Overview of sensor fusion processing) FIGS. 4A and 4B schematically show the sensor fusion process used for object recognition in this embodiment, that is, the processing contents in the integration processing function 604 shown in FIG. 3. Such sensor fusion process uses so-called DBF, which is one of the rectangle-level integration techniques. DBF stands for Dynamic Belief Fusion. DBF models three hypotheses, namely, “target,” “non-target,” and “intermediate state,” by calculating a confidence level from a precision-recall curve based on the detection score s for each of multiple detection results. Thus, DBF achieves more accurate fusion. The detection score s is a value indicating the likelihood of a recognition object, that is, the likelihood of a vehicle or a pedestrian. For more information on DBF, see the following papers: “DBF: Dynamic Belief Fusion for Combining Multiple Object Detectors”, IEEE Transactions on Pattern Analysis and Machine Intelligence (Volume: 43, Issue: 5), Page(s): 1499-1514.

FIG. 4A shows a specific example in which a car is recognized as another vehicle from sensor detection information. In FIG. 4A, the first sensor information 711 is detection information of the first sensor 21. The first detection rectangle 712 is a bounding box provided in the first sensor information 711. As shown in FIG. 4A, the object detection result information in the object detection function 602 shown in FIG. 3 includes the detection result of a car as a “target” within the first detection rectangle 712, along with a detection score s for the detected object being a car.

The first confidence calculation function 713 calculates the confidence levels, or basic probabilities, for three hypotheses—“target,” “non-target,” and “intermediate state”—for the object detection result information based on the detection information of the first sensor 21. The calculation result of the confidence level for each of the three hypotheses by the first confidence calculation function 713 is shown as first confidence assignment information 714. The first confidence assignment information 714 includes basic probability assignments p(T), p(NT), and p(I) for the detected object within the first detection rectangle 712. p(T) denotes the basic probability that the detected object in the first detection rectangle 712 is a car as the “target”. p(NT) denotes the basic probability that the detected object in the first detection rectangle 712 is a non-car as a “non-target”. p(I) denotes the basic probability that the detected object in the first detection rectangle 712 is in an “intermediate state”. In other words, p(I) represents the probability that the detected object is unknown as to whether it is a car or not. The concepts of “the basic probability” and “the basic probability assignment” are based on the Dempster-Shafer theory and already well known at the time of filing this application, so detailed explanations (e.g., mathematical formulas) other than those described below will be omitted in this specification.

Similarly, the second sensor information 721 is detection information of the second sensor 22. The second detection rectangle 722 is a bounding box provided in the second sensor information 721. The second confidence calculation function 723 calculates the confidences of three hypotheses—“target”, “non-target”, and “intermediate state”—for the object detection result information based on the detection information of the second sensor 22. The calculation result of the confidence level for each of the three hypotheses by the second confidence calculation function 723 is shown as second confidence assignment information 724. The second confidence assignment information 724 includes the basic probability assignments p(T), p(NT), and p(I) for the detected object within the second detection rectangle 722. Similar processing is performed on the detection information from the third sensor 23 and the fourth sensor 24, and a basic probability assignment corresponding to each of the third sensor 23 and the fourth sensor 24 is output.

The basic probability assignment will be described with reference to a diagram in FIG. 4B showing an example where the third confidence calculation function 733 outputs third confidence assignment information 734 based on the detection information of the third sensor 23. First, the third confidence calculation function 733 generates a detection performance curve for the corresponding object sensor 2, i.e., the third sensor 23. In this embodiment, the detection performance curve is a precision-recall curve. The precision-recall curve is hereinafter abbreviated as “PR curve”. In the “PR curve,” “P” stands for Precision (i.e., precision rate) and “R” stands for Recall (i.e., recall rate).

Specifically, the third confidence calculation function 733 generates PR curve information 751. The PR curve information 751 includes a theoretical PR curve PRi that is a PR curve indicating an estimated theoretical performance of the third sensor 23, and an actual PR curve PRr that is a PR curve indicating the actual performance of the third sensor 23. The theoretical PR curve PRi is expressed as “1−rⁿ” as shown in the following equation (1). The above formula (1) is quoted from the above paper.

$${\hat{p}}_{bpd} ( r ) = 1 - {r}^{n} \qquad ( Equation 1 )$$

In the PR curve information 751, p(T) is expressed as the value on the actual PR curve PRr at the recall rate r(s) corresponding to the detection score s. In other words, p(T) is the difference between the baseline of the precision rate=0 and the actual PR curve PRr at the recall rate r(s). p(NT) is a value expressed by the following formula (2). That is, p(NT) is the difference between the theoretical PR curve PRi at the recall rate r(s) and the horizontal line of the precision rate=1. p(I) is a value expressed by the following formula (3). In other words, p(I) is the difference between the actual PR curve PRr and the theoretical PR curve PRi at the recall rate r(s).

$$1 - {\hat{p}}_{bpd} \qquad ( Equation 2 )$$

$${\hat{p}}_{bpd} - p \qquad ( Equation 3 )$$

The graph illustrated between the PR curve information 751 and the third confidence assignment information 734 shows assignment function information 752. The assignment function information 752 shows p(T), p(NT), and p(I) as a function of the detection score s. The third confidence assignment information 734 indicates the basic probability assignment p(T), p(NT), and p(I) for the detection score s. Then, as shown in FIG. 4A, the first confidence assignment information 714, the second confidence assignment information 724, the third confidence assignment information 734, and so on which are the calculated basic probability assignments, are combined, that is, integrated, according to a combination rule 753. The combination rule 753 may be, for example, the Dempster combination rule.

In this embodiment, the exponential parameter n in the theoretical PR curve PRi shown in the above equation (1) is determined or adjusted in accordance with feedback information of the object recognition results and the driving scene, thereby further improving the recognition accuracy. That is, the integration processing function 604 generates a theoretical PR curve PRi as the detection performance curve based on the driving environment of the vehicle and/or feedback information of the object recognition results by the object recognition processing function 605. Furthermore, the integration processing function 604 uses the generated theoretical PR curve PRi to calculate the confidence level of the object detection result, i.e., the basic probability assignment, for each of the various types of the object sensors 2, and integrates the calculated assignments. Then, the object recognition processing function 605 performs object recognition based on the integration result.

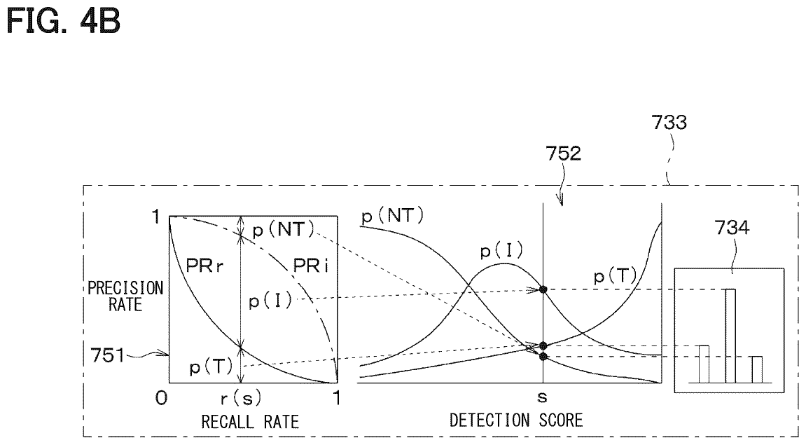

(Operation example) Hereinafter, with reference to the drawings, the operation of the object recognition device 6 according to this embodiment will be schematically described, along with the effects achieved by the object recognition method and object recognition program executed thereby. In the flowchart shown in the drawings such as FIG. 5, “S” is an abbreviation for “step”. Furthermore, the object recognition device 6 according to this embodiment, the object recognition method, and the object recognition program executed thereby may be collectively referred to as “this embodiment” hereinafter.

FIG. 5 schematically shows the integration process performed by the integration processing function 604 shown in FIG. 3. First, in step S101, the processor 61 in the object recognition device 6 calculates the confidence level of the object detection result, that is, the basic probability assignment, for each of the various types of the object sensors 2. Next, in step S102, the processor 61 integrates the calculated basic probability assignment for each of the various types of the object sensors 2.

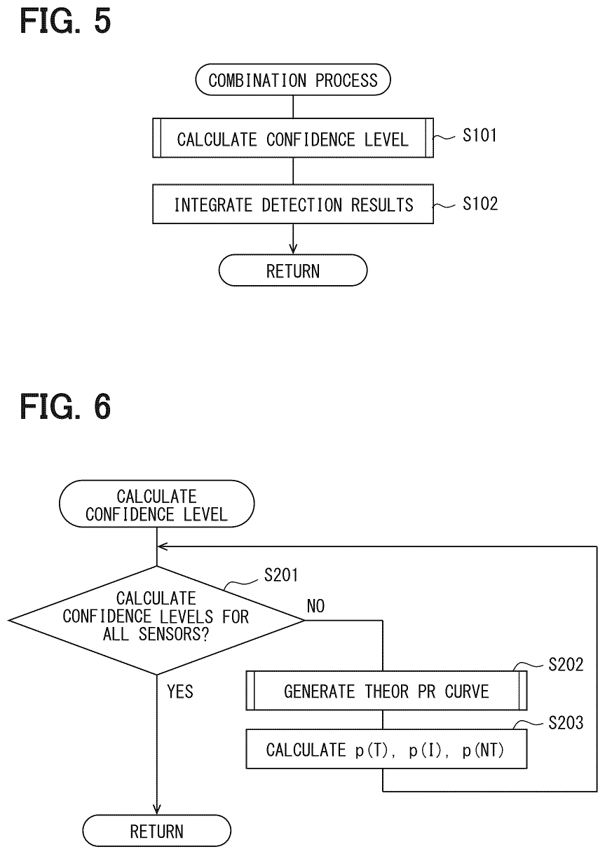

FIG. 6 shows the specific contents of the confidence calculation process in step S101. First, in step S201, the processor 61 determines whether the calculation of the confidence levels for the object detection results, that is, the basic probability assignments, has been completed for all the object sensors 2 (i.e., the first sensor 21 to the fourth sensor 24 in this example). Until the calculation is completed for all the object sensors 2, the determination result in step S201 will be “NO”, and the processor 61 executes the process of step S202 and step S203 and returns the process to step S201. When the calculation has been completed for all the object sensors 2, the determination result in step S201 will be “YES”, and the processor 61 temporarily ends the process of the flowchart shown in FIG. 6 and moves the process to step S102 shown in FIG. 5. In step S202, the processor 61 generates a theoretical PR curve PRi. In step S203, the processor 61 calculates basic probability assignments p(T), p(NT), and p(I) using the theoretical PR curve PRi generated in step S202.

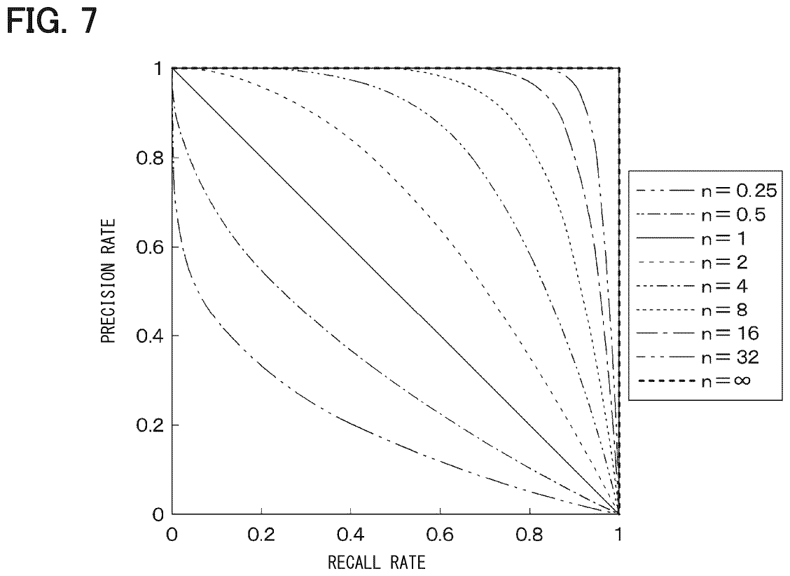

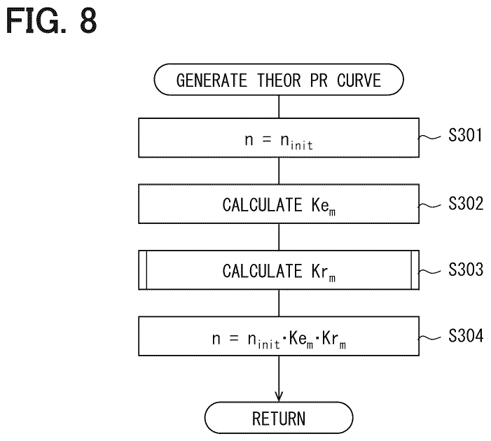

The generation of the theoretical PR curve PRi in step S202 will be described with reference to FIGS. 7 and 8. FIG. 7 shows theoretical PR curves PRi having different values of the exponential parameter n. As shown in FIG. 7, the theoretical PR curve PRi behaves differently based on the exponential parameter n. When n=1, the theoretical PR curve PRi is a straight line sloping downward to the right, when n<1, the theoretical PR curve PRi is a convex shape heading to the lower left, and when n>1, the theoretical PR curve PRi is a convex shape heading to the upper right. When n=∞, the theoretical PR curve PRi shows a rectangular wave shape with the precision rate being 1 in the range of the recall rate r<1 and the precision rate dropping from 1 to 0 at the recall rate r=1.

FIG. 8 shows specific contents of the theoretical PR curve generation process in step S202. First, in step S301, the processor 61 sets the exponent parameter n to an initial value nᵢₙᵢₜ. The initial value nᵢₙᵢₜ is a predetermined value according to the type of the object sensor 2, and can be obtained, for example, by optimization experiments, computer simulations, or the like. Next, in step S302, the processor 61 calculates a first coefficient Keₘ to be multiplied by the initial value nᵢₙᵢₜ. Subsequently, in step S303, the processor 61 calculates a second coefficient Krₘ to be multiplied by the initial value nᵢₙᵢₜ. Then, in step S304, the processor 61 determines the exponent parameter n by multiplying the initial value nᵢₙᵢₜ by the first coefficient Keₘ and the second coefficient Krₘ.

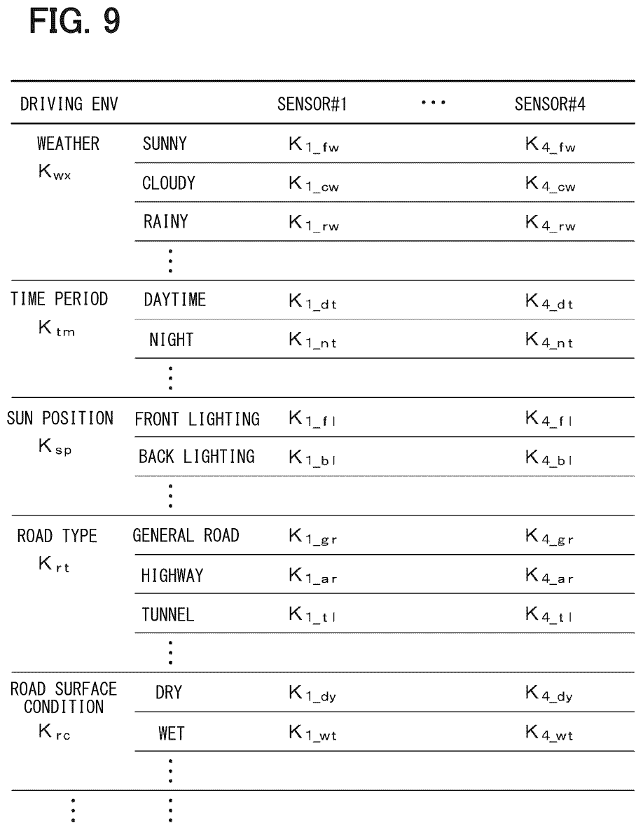

The first coefficient Keₘ is a coefficient corresponding to the driving scene or driving environment of the vehicle. The first coefficient Keₘ is obtained by multiplying a weather coefficient K_{wx}, a time period coefficient Kₜₘ, a sun position coefficient Kₛₚ, a road type coefficient Kᵣₜ, a road surface condition coefficient K_{rc}, and the like shown in FIG. 9. If the driving scene or the driving environment of the vehicle is determined to adversely affect the detection or sensing of the object B by the object sensor 2, the probability of erroneous detection increases. Thus, in this case, the value of the exponent parameter n is preferably decreased to increase the confidence level of non-target. Therefore, these coefficients constituting the first coefficient Keₘ are numerical values between 0 (exclusive) and 1 (inclusive). These coefficients are set to smaller values under worse conditions. The driving scene or driving environment can be determined based on detection information from the object sensors 2 (e.g., images of the sky or raindrops captured by a camera), output information from the vehicle state sensors 4, output information from the locator 5, road traffic information or weather information obtained from an external server, and the like. The details of these representative coefficients will be explained below in order.

In fine weather, the weather coefficient K_{wx} is set to K_{1_fw} for the first sensor 21, K_{2_fw} for the second sensor 22, K_{3_fw} for the third sensor 23, and K_{4_fw} for the fourth sensor 24. In cloudy weather, the weather coefficient K_{wx} is set to K_{1_cw} for the first sensor 21, K_{2_cw} for the second sensor 22, K_{3_cw} for the third sensor 23, and K_{4_cw} for the fourth sensor 24. In rainy weather, the weather coefficient K_{wx} is set to K_{1_rw} for the first sensor 21, K_{2_rw} for the second sensor 22, K_{3_rw} for the third sensor 23, and K_{4_rw} for the fourth sensor 24. The values of these weather coefficients K_{wx} are determined based on the strengths and weaknesses of the first sensor 21 to the fourth sensor 24 using optimization experiments, computer simulations, or the like. The weather can be determined based on, for example, camera images, the output from the rain sensor 43, weather information obtained from an external server, and the like.

In the daytime, the time period coefficient Kₜₘ is K_{1_dt} for the first sensor 21, K_{2_dt} for the second sensor 22, K_{3_dt} for the third sensor 23, and K_{4_dt} for the fourth sensor 24. In the nighttime, the time period coefficient Kₜₘ is set to K_{1_nt} for the first sensor 21, K_{2_nt} for the second sensor 22, K_{3_nt} for the third sensor 23, and K_{4_nt} for the fourth sensor 24. The values of these time period coefficients Kₜₘ are determined based on the strengths and weaknesses of the first sensor 21 to the fourth sensor 24 using optimization experiments, computer simulations, or the like. The time period can be determined using, for example, output information from the locator 5 or output information from a clock (not shown) mounted on the vehicle configured to output date information and time information.

In the case of front lighting, the sun position coefficient Kₛₚ is set to K_{1_fl} for the first sensor 21, K_{2_fl} for the second sensor 22, K_{3_fl} for the third sensor 23, and K_{4_fl} for the fourth sensor 24. In the case of back lighting, the sun position coefficient Kₛₚ is set to K_{1_bl} for the first sensor 21, K_{2_bl} for the second sensor 22, K_{3_bl} for the third sensor 23, and K_{4_bl} for the fourth sensor 24. The values of the sun position coefficients Kₛₚ are determined based on the strengths and weaknesses of the first sensor 21 to the fourth sensor 24 using optimization experiments, computer simulations, or the like. Whether the light is coming from behind or ahead may be determined based on camera images, the direction of the vehicle obtained from output information by the vehicle state sensors 4 and/or the locator 5, and the altitude and direction of the sun calculated from the date and time period.

When the vehicle moves on a general road, the road type coefficient Kᵣₜ is set to K_{1_gr} for the first sensor 21, K_{2_gr} for the second sensor 22, K_{3_gr} for the third sensor 23, and K_{4_gr} for the fourth sensor 24. When the vehicle moves on a highway, the road type coefficient Kᵣₜ is set to K_{1_ar} for the first sensor 21, K_{2_ar} for the second sensor 22, K_{3_ar} for the third sensor 23, and K_{4_ar} for the fourth sensor 24. When the vehicle moves through a tunnel, the road type coefficient Kᵣₜ is set to K_{1_tl} for the first sensor 21, K_{2_tl} for the second sensor 22, K_{3_tl} for the third sensor 23, and K_{4_tl} for the fourth sensor 24. The values of the road type coefficients Kᵣₜ are determined based on the strengths and weaknesses of the first to fourth sensors 21 to 24, using optimization experiments, computer simulations, or the like. The road type can be determined based on, for example, output information from the locator 5 and map information.

In the case of a dry road surface, the road surface condition coefficient K_{rc} is K_{1_dy} for the first sensor 21, K_{2_dy} for the second sensor 22, K_{3_dy} for the third sensor 23, and K_{4_dy} for the fourth sensor 24. In the case of a wet road surface, the road surface condition coefficient K_{rc} is set to K_{1_wt} for the first sensor 21, K_{2_wt} for the second sensor 22, K_{3_wt} for the third sensor 23, and K_{4_wt} for the fourth sensor 24. The values of the road surface condition coefficients K_{rc} are determined based on the strengths and weaknesses of the first sensor 21 to the fourth sensor 24 using optimization experiments, computer simulations, or the like. The road surface condition can be determined based on, for example, camera images or output information from the moisture sensor 44.

The second coefficient Krₘ is a coefficient according to feedback information of the object recognition result by the object recognition processing function 605. That is, the second coefficient Krₘ reflects the object recognition result from one time period earlier. The “one time period” refers to one object recognition cycle (for example, 10 msec). A high similarity between the detection value at the current time and the predicted value at the current time (i.e., this time) predicted based on the object recognition result from one time period earlier (i.e., the previous time) indicates that the target object is tracked with high accuracy. Thus, in this case, the value of the exponent parameter n is preferably increased to decrease the confidence of non-target. Therefore, each of the coefficients constituting the second coefficient Krₘ, which will be described later, is a numerical value between 0 (exclusive) and 1 (inclusive), and is set to greater values when the target object is tracked with higher accuracy.

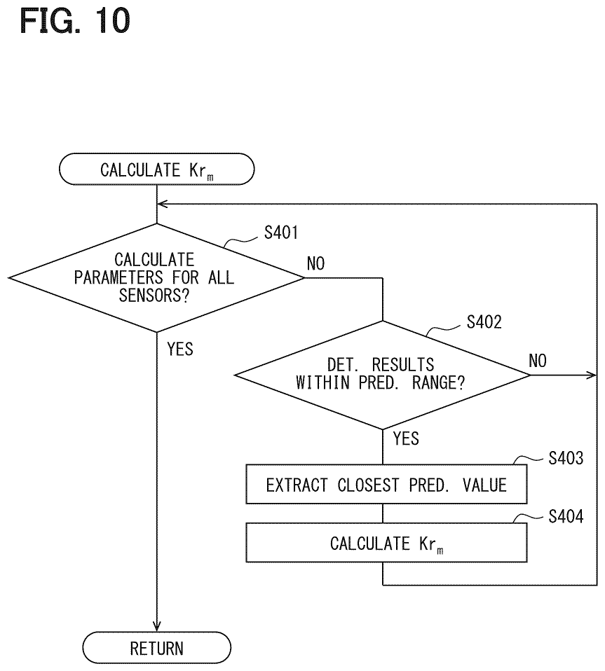

FIG. 10 shows specific contents of the second coefficient Krₘ calculation process in step S303. First, in step S401, the processor 61 determines whether the calculation of the exponent parameter n, that is, the second coefficient Krₘ, has been completed for all the object sensors 2 (i.e., the first sensor 21 to the fourth sensor 24 in this example). Until the calculation has been completed for all the object sensors 2, the determination result in step S401 will be “NO”, and the processor 61 moves the process to step S402.

In step 402, the processor 61 determines whether the detection result corresponding to the current detection score s is within the predicted range. That is, the processor 61 determines whether the bounding box in the current detection information is within a predicted range calculated based on the bounding box from the previous detection information. The predicted range may be calculated from the previous detection information based on the relative movement direction and relative movement speed between the vehicle and the target object. Specifically, at first, a predicted bounding box is generated using the previous detection information including the position, width, depth, direction, speed, and angular velocity. Next, margins are added to the width and depth of this predicted bounding box to generate a slightly larger bounding box, which is used as the predicted range. When the determination in step S402 is “NO”, the processor 61 returns the process to step S401. When the determination result in step S402 is YES, the processor 61 executes processing of step S403 and S404, and returns the process to step S401.

In step 403, the processor 61 extracts a predicted value that is closest to the detection result corresponding to the current detection score s. That is, the processor 61 sets a bounding box having the same size as the bounding box in the previous detection information to be closest to the bounding box in the current detection information within the predicted range, and sets this bounding box as the predicted value. In other words, the processor 61 determines, as a predicted value, the closest predicted bounding box that overlaps with the current detection result and is closest in distance to the predicted bounding box. The parameters of the position, size, and the like of the bounding box in the current detection information will be referred to as “measured values” hereinafter.

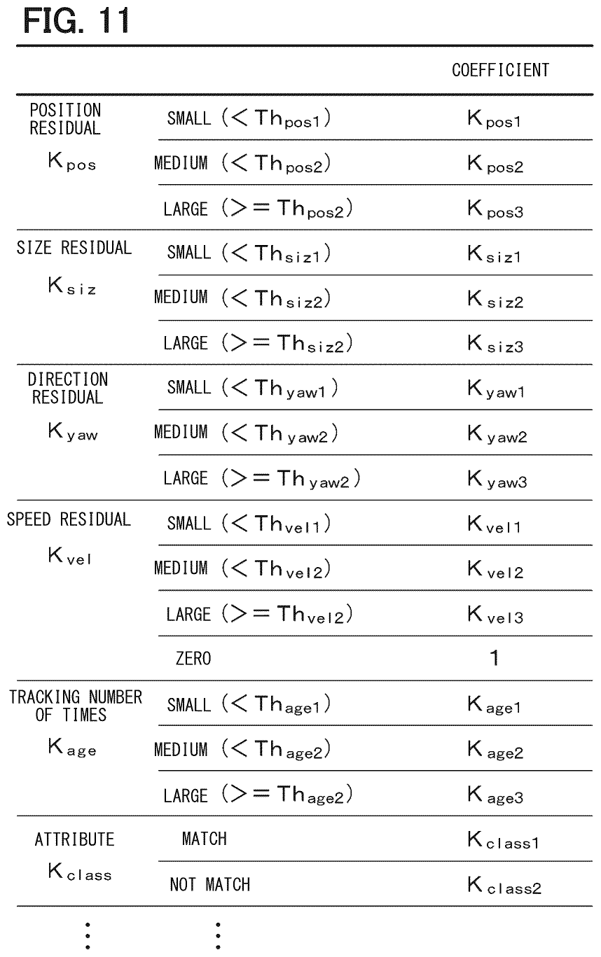

In step 404, the processor 61 calculates the second coefficient Krₘ based on the predicted value and the measured value. As shown in FIG. 11, the second coefficient Krₘ is obtained by multiplying a position residual coefficient Kₚₒₛ, a size residual coefficient K_{siz}, a direction residual coefficient K_{yaw}, a speed residual coefficient Kᵥₑₗ, a tracking number coefficient K_{age}, an attribute coefficient K_{class}, and the like. The representative coefficients described above will be described in order.

The position residual coefficient Kₚₒₛ is a coefficient related to the position residual, that is, the difference between the predicted value and the measured value of a reference point of the bounding box (for example, any one of the four corner points or the center point). When the position residual is small, that is, less than the first position residual threshold Thₚₒₛ₁, the position residual coefficient Kₚₒₛ=Kₚₒₛ₁. When the position residual is medium, that is, between the first position residual threshold value Thₚₒₛ₁ and the second position residual threshold value Thₚₒₛ₂, the position residual coefficient Kₚₒₛ=Kₚₒₛ₂. When the position residual is large, that is, equal to or greater than the second position residual threshold value Thₚₒₛ₂, the position residual coefficient Kₚₒₛ=Kₚₒₛ₃. The relationship of Kₚₒₛ₁, Kₚₒₛ₂, Kₚₒₛ₃ is represented as 1>Kₚₒₛ₁>Kₚₒₛ₂>Kₚₒₛ₃>0.

The size residual coefficient K_{siz} is a coefficient related to the size residual, i.e., the difference between the size of the predicted bounding box and the size of the measured bounding box. If the size residual is small, that is, less than the first size residual threshold Th_{siz1}, the size residual coefficient K_{siz}=K_{siz1}. When the size residual is medium, that is, between the first size residual threshold Th_{siz1} and the second size residual threshold Th_{siz2}, the size residual coefficient K_{siz}=K_{siz2}. When the size residual is large, that is, equal to or greater than the second size residual threshold Th_{siz2}, the size residual coefficient K_{siz}=K_{siz3}. The relationship of K_{siz1}, K_{siz2}, K_{siz3} is expressed as 1>K_{siz1}>K_{siz2}>K_{siz3}>0.

The direction residual coefficient K_{yaw} is a coefficient related to the direction residual, that is, the difference between the predicted direction and measured direction of the bounding box. When the direction residual is small, that is, less than the first direction residual threshold Th_{yaw1}, the direction residual coefficient K_{yaw}=K_{yaw1}. When the direction residual is medium, that is, between the first direction residual threshold Th_{yaw1} and the second direction residual threshold Th_{yaw2}, the direction residual coefficient K_{yaw}=K_{yaw2}. When the direction residual is large, that is, equal to or greater than the second direction residual threshold Th_{yaw2}, the direction residual coefficient K_{yaw}=K_{yaw3}. The relationship of K_{yaw1}, K_{yaw2}, and K_{yaw3} is expressed as 1>K_{yaw1}>K_{yaw2}>K_{yaw3}>0.

The speed residual coefficient Kᵥₑₗ is a coefficient related to the speed residual, that is, the difference between the predicted value and measured value of the moving speed of the bounding box. When the speed residual is small, that is, less than the first speed residual threshold Thᵥₑₗ₁, the speed residual coefficient Kᵥₑₗ=Kᵥₑₗ₁. When the speed residual is medium, that is, between the first speed residual threshold value Thᵥₑₗ₁ and the second speed residual threshold value Thᵥₑₗ₂, the speed residual coefficient Kᵥₑₗ=Kᵥₑₗ₂. When the speed residual is large, that is, equal to or greater than the second speed residual threshold value Thᵥₑₗ₂, the speed residual coefficient Kᵥₑₗ=Kᵥₑₗ₃. When there is no speed residual, that is, when the speed residual is zero, the speed residual coefficient Kᵥₑₗ=1. The relationship of Kᵥₑₗ₁, Kᵥₑₗ₂, Kᵥₑₗ₃ is expressed as 1>Kᵥₑₗ₁>Kᵥₑₗ₂>Kᵥₑₗ₃>0.

The tracking number coefficient K_{age} is a coefficient related to the tracking number of times for the same object. When the tracking number is small, that is, less than the first tracking number threshold value Th_{age1}, the tracking number coefficient K_{age}=K_{age1}. When the tracking number is medium, that is, between the first tracking number threshold value Th_{age1} and the second tracking number threshold value Th_{age2}, the tracking number coefficient K_{age}=K_{age2}. When the tracking number is large, that is, equal to or greater than the second tracking number threshold value Th_{age2}, the tracking number coefficient K_{age}=K_{age3}. The relationship of K_{age1}, K_{age2}, K_{age3} is expressed as 1>K_{age3}>K_{age2}>K_{age1}>0.

The attribute coefficient K_{class} is a coefficient related to the match/mismatch of attributes in detected objects. The “attribute” is, for example, a car, a pedestrian, and the like. If the attributes match, the attribute coefficient K_{class}=K_{class1}. If the attributes do not match, the attribute coefficient K_{class}=K_{class2}. The relationship of K_{class1} and K_{class2} is expressed as 1>K_{class1}>K_{class2}>0.

As described above, this embodiment generates a theoretical PR curve PRi, which is a PR curve that indicates the estimated theoretical performance of the object sensor 2, and an actual PR curve PRr, which is a PR curve that indicates the actual performance of the object sensor 2. In addition, this embodiment determines the exponent parameter n based on the current driving scene or driving environment of the vehicle and feedback information of the previous recognition result (i.e., the recognition result from one time period earlier) to generate the theoretical PR curve PRi for each of the object sensors 2. This makes it possible to generate an appropriate detection performance curve for each of the object sensors 2 according to the current operating conditions. Therefore, this embodiment further improves the object recognition accuracy based on sensor fusion processing to which the Dempster-Shafer theory or DBF is applied.

(Modifications) The present disclosure is not limited to the embodiment and the examples described above. Therefore, the above embodiments can be appropriately changed. Hereinafter, typical modifications will be described. In the following description of the modifications, differences from the above embodiments will be mainly described. In the above embodiments and the following modifications, the same reference numerals are assigned to the same or equivalent parts. Therefore, in the following description of the modifications, the description in the above embodiments can be appropriately incorporated for the components having the same reference numerals as those in the above embodiments, unless there is a technical contradiction or a special additional description.

The present disclosure is not limited to the specific applications and device configuration described in the above embodiment. That is, for example, the vehicle may be a so-called car or a motorcycle. There are no particular limitations on the type of car or motorcycle. Furthermore, the “object B” is not limited to targets in following vehicle driving or in collision avoiding, such as other vehicles or obstacles. The object B may be, for example, road signs, traffic lights, road marks, and the like. In other words, the “object B” can also be called a “target.” Therefore, the object recognition device 6 according to the present disclosure may also be referred to as a “target recognition device.”

The in-vehicle system 1 may be configured to achieve “autonomous driving” of level 3 or higher as defined in “SAE J3016.” In this case, the driving assistance device 3 has a configuration as a so-called autonomous driving ECU. The types of object sensors 2 are not limited to the four types exemplified in the above embodiment, and may be two types, three types, or five or more types. In addition, the present disclosure can also be suitably applied to fusion processing between multiple object sensors 2 having the same detection principle but different effective detection ranges. For example, the present disclosure can be applied to fusion processing between a long-range radar, a medium-range radar, and a short-range radar. In this sense, “various types of object sensors 2” may be multiple object sensors 2 having the same detection principle but different effective detection ranges or operating frequency bands.

For example, all or part of the object recognition device 6 may include a digital circuit configured to enable the above-mentioned functions and operations, for example, an ASIC or an FPGA. ASIC is an abbreviation for Application Specific Integrated Circuit. The FPGA is an abbreviation for Field Programmable Gate Array. That is, a part of the object recognition device 6 configured by the in-vehicle microcontroller and a part of the object recognition device 6 configured by the digital circuit can coexist.

The program according to the present embodiment capable of performing various operations, procedures, or processing described in the above embodiment can be downloaded or upgraded via V2X communication. V2X is an abbreviation for Vehicle to X. Alternatively, such a program can be downloaded or upgraded via terminal equipment provided in a manufacturing factory, a maintenance factory, a dealership, or the like of a vehicle. The program may be stored in a memory card, an optical disk, a magnetic disk, or the like.

As described above, each functional configuration and processes described above may be implemented by a dedicated computer configured by the processor 61 and the storage medium 62 programmed to execute one or multiple functions embodied by a computer program. Alternatively, each functional configuration and processes described above may be implemented by a dedicated computer provided by configuring the processor 61 using one or more dedicated hardware logic circuits. Alternatively, each functional configuration and processes described above may be implemented by one or more dedicated computers configured with a combination of at least one processor 61 and at least one storage medium 62 programmed to execute one or multiple functions and another processor 61 configured using one or more hardware logic circuits. The computer program may be stored in a computer-readable non-transitory tangible storage medium as an instruction to be executed by the computer. That is, each functional configuration, processes and method described above can also be expressed as a computer program including procedures for implementing the functional configuration and method, or a non-transitory tangible storage medium storing the program.

The present disclosure is not limited to the specific operation modes and functions shown in the above embodiments. That is, for example, instead of the Dempster combination rule, other well-known combination rules such as the Yager combination rule can be used as the combination rule 753. In addition, the flowcharts shown in the drawings can be modified as appropriate. Specifically, for example, one of the first coefficient Keₘ and the second coefficient Krₘ may be omitted. That is, the object recognition device 6 may determine the exponent parameter n using the current driving scene (or driving environment) of the vehicle or feedback information of the previous recognition result (i.e., the recognition result from one time period earlier). Also, in step S403, the predicted value, i.e., the closest bounding box may be the predicted bounding box.

Similar expressions such as “acquisition”, “calculation”, “estimation”, “detection”, and “sensing” can be appropriately replaced with one another within a range free from technical conflict. Furthermore, the terms “exceeding the threshold value” and “equal to or greater than the threshold value” can be used interchangeably as appropriate within the scope of any technical contradiction. The same applies to “less than a threshold” and “equal to or greater than a threshold”.

The constituent element(s) of each of the above embodiments and the above modifications is/are not necessarily essential unless it is specifically stated that the constituent element(s) is/are essential in the above embodiments, or unless the constituent element(s) is/are obviously essential in principle. In addition, in the case where the number of the constituent element(s), the value, the amount, the range, and/or the like is specified, the present disclosure is not necessarily limited to the number of the constituent element(s), the value, the amount, and/or the like specified in the embodiment unless the number of the constituent element(s), the value, the amount, and/or the like is indicated as essential or is obviously essential in view of the principle. Similarly, in the case where the shape, the direction, the positional relationship, and/or the like of the constituent element(s) is specified, the present disclosure is not necessarily limited to the shape, the direction, the positional relationship, and/or the like unless the shape, the direction, the positional relationship, and/or the like is/are indicated as essential or is/are obviously essential in principle.

The modifications are also not necessarily limited to the above examples. For example, all or part of one embodiment and all or part of another embodiment can be combined together as long as there is no technical conflict. There is no particular limitation on the number of combinations. Similarly, all or part of one of the modifications and all or part of another one of the modifications may be combined with together as long as there is no technical conflict. Furthermore, all or part of the above-described embodiments and all or part of the above-described modifications may be combined together other as long as there is no technical conflict.

1. An object recognition device disposed in a vehicle for recognizing an object around the vehicle with various types of object sensors in the vehicle, the object recognition device comprising:
a sensor information obtaining unit configured to obtain detection information from each of the various types of object sensors;
an object detecting unit configured to generate an object detection result for each of the various types of object sensors corresponding to the detection information obtained by the sensor information obtaining unit;
an integration processing unit configured to:
generate a detection performance curve for each of the various types of object sensors;
calculate a confidence level of the object detection result for each of the various types of object sensors using the detection performance curve; and
generate an integrated result by integrating the confidence level of the object detection result for each of the various types of object sensors; and
a recognition processing unit configured to generate an object recognition result by recognizing the object based on the integrated result by the integration processing unit, wherein
the integration processing unit is further configured to generate the detection performance curve based on at least one of a driving environment of the vehicle or feedback information of the object recognition result by the recognition processing unit.

2. The object recognition device according to claim 1, wherein
the integration processing unit is further configured to generate, as the detection performance curve, a theoretical PR curve and an actual PR curve,
the theoretical PR curve is a precision-recall curve indicating estimated theoretical performance for one of the various types of object sensors, and
the actual PR curve is a precision-recall curve indicating actual performance for the one of the various types of object sensors.

3. The object recognition device according to claim 2, wherein
the integration processing unit is configured to determine the theoretical PR curve for each of the various types of object sensors based on the driving environment.

4. The object recognition device according to claim 2, wherein
the integration processing unit is configured to determine the theoretical PR curve for each of the various types of object sensors based on the feedback information.

5. The object recognition device according to claim 4, wherein
the integration processing unit is configured to determine the theoretical PR curve for each of the various types of object sensors by determining an exponential parameter for the theoretical PR curve that is represented by 1−rⁿ.

6. An object recognition method executed by an object recognition device that is disposed in a vehicle and configured to recognize an object around the vehicle with various types of object sensors in the vehicle, the object recognition method comprising:
obtaining detection information from each of the various types of object sensors;
generating an object detection result for each of the various types of object sensors corresponding to the obtained detection information;
generating a detection performance curve for each of the various types of object sensors;
calculating a confidence level of the object detection result for each of the various types of object sensors using the detection performance curve;
generating an integrated result by integrating the calculated confidence level for each of the various types of object sensors; and
generating an object recognition result by recognizing the object based on the integrated result of the confidence level, wherein
the generating of the detection performance curve is generating the detection performance curve based on at least one of a driving environment of the vehicle or feedback information of the object recognition result.

7. The object recognition method according to claim 6, wherein
the generating of the detection performance curve is generating a theoretical PR curve and an actual PR curve,
the theoretical PR curve is a precision-recall curve indicating estimated theoretical performance for one of the various types of object sensors, and
the actual PR curve is a precision-recall curve indicating an actual performance for the one of the various types of object sensors.

8. The object recognition method according to claim 7, wherein
the generating of the theoretical PR curve includes determining the theoretical PR curve for each of the various types of object sensors based on the driving environment.

9. The object recognition method according to claim 7, wherein
the generating of the theoretical PR curve includes determining the theoretical PR curve for each of the various types of object sensors based on the feedback information.

10. The object recognition method according to claim 9, wherein
the determining of the theoretical PR curve includes determining an exponential parameter for the theoretical PR curve which is represented by 1−rⁿ.

11. A non-transitory computer readable storage medium storing an object recognition program executed by an object recognition device that is mounted in a vehicle and configured to recognize an object around the vehicle with various types of object sensors in the vehicle, the object recognition program being configured to cause the object recognition device to:
obtain detection information from each of the various types of object sensors;
generate an object detection result for each of the various types of object sensors corresponding to the obtained detection information;
generate a detection performance curve for each of the various types of object sensors;
calculate a confidence level of the object detection result for each of the various types of object sensors using the detection performance curve;
generate an integrated result by integrating the calculated confidence level for each of the various types of object sensors; and
generate an object recognition result by recognizing the object based on the integrated result of the confidence level for each of the various types of sensors, wherein
the object recognition program is configured to cause the object recognition device to generate the detection performance curve based on at least one of a driving environment of the vehicle or feedback information of the object recognition result.

12. The non-transitory computer readable storage medium according to claim 11, wherein
the object recognition program is configured to cause the object recognition device to generate a theoretical PR curve and an actual PR curve as the detection performance curve,
the theoretical PR curve is a precision-recall curve indicating estimated theoretical performance for one of the various types of object sensors, and
the actual PR curve is a precision-recall curve indicating actual performance for the one of the various types of object sensors.

13. The non-transitory computer readable storage medium according to claim 12, wherein
the object recognition program is configured to cause the object recognition device to determine the theoretical PR curve for each of the various types of object sensors based on the driving environment.

14. The non-transitory computer readable storage medium according to claim 12, wherein
the object recognition program is configured to cause the object recognition device to determine the theoretical PR curve for each of the various types of object sensors based on the feedback information.

15. The non-transitory computer readable storage medium according to claim 14, wherein
the object recognition program is configured to cause the object recognition device to determine the theoretical PR curve for each of the various types of object sensors by determining an exponential parameter for the theoretical PR curve which is represented by 1−rⁿ.
